(19) United States
(12) Patent Application Publication
(10) Pub. No.: US 2014/0349789 A1
(43) Pub. Date: Nov. 27, 2014

(54) PRE-FORMED LACROSSE POCKET

(71) Applicants: ANDREW SZURLEY, LINCOLN, RI (US); VAN HILES, GREENWELL SPRINGS, LA (US); JIM STALLMAN, PROVIDENCE, RI (US)

(72) Inventors: ANDREW SZURLEY, LINCOLN, RI (US); VAN HILES, GREENWELL SPRINGS, LA (US); JIM STALLMAN, PROVIDENCE, RI (US)

(21) Appl. No.: 14/285,617

(22) Filed: May 22, 2014

Related U.S. Application Data
(60) Provisional application No. 61/826,103, filed on May 22, 2013.

(51) Int. Cl. A63B 59/02; B29C 65/72

(52) U.S. Cl. CPC A63B 59/02; B29C 65/72; B29L 2031/52
USPC 473/513; 156/222

(57) ABSTRACT

An aspect of the present invention relates to a lacrosse pocket comprising a preformed composite material including an outer edge for attaching to a lacrosse head and an interior channel within the outer edge having a desired concave shape and depth, wherein the interior channel, for receiving and releasing a lacrosse ball, permanently maintains the desired concave shape and depth.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to a lacrosse product. More specifically, the present invention relates to a lacrosse pocket for a lacrosse head.

For the past 25-30 years, “broken in” hard mesh and traditionally strung pockets have been the benchmark by which we judge a quality pocket. Each of these methods use traditional mesh materials. The mesh materials rely on wax to allow the mesh material to maintain a broken in pocket. These mesh materials are affected though by weather, user use and other variations.

There are limits, though, to what the mesh materials can offer. Off the store shelf, the mesh is generally hard as a rock due to the heavy wax coating, and therefore, it has no “ball feel” until the time is taken to break in the mesh, typically 1000+ reps of passing and catching. For most entry level, and a large majority of intermediate players, this is not a reality due to the speeds and force needed to “break the pocket in”. Also, by the time the pocket is broken in, the life of the pocket is limited due to the wear caused by breaking it in.

Additionally, users neither have the time nor the knowledge to break in a pocket that can be reliable and or consistent. Also their limited knowledge of sidewall and throw-string adjustments hinder how effective they can be as players from day 1. This equipment hurdle can be a “make or break scenario” for a player that has athletic ability but trouble overcoming the skill part of handling a ball in the crosse. An example of a prior art mesh material pocket on a lacrosse head and stick is illustrated in FIG. 1.

Current preformed pockets suffer from a similar issue as above. The mesh material that is used for preformed pockets, disclosed in U.S. Pat. No. 7,338,396, are made from the same material, mesh material with heavy wax that requires specific packaging to be used during shipping. Once this preformed pocket has been attached to the lacrosse head, the pocket requires continuous breaking in and/or kept in the packaging in order to keep the shape of the preformed pocket. Unfortunately, the preformed pockets disclosed in the '396 patent are not able to maintain the required shape over a long period of time, thereby leaving the user to breaking in the material.

Accordingly, there exists a need for an improved pre-formed lacrosse pocket.

### SUMMARY OF THE INVENTION

One aspect of the present invention relates to the development of a pre-molded, at depth (“broken in”) pocket to aid with the early and intermediate development of basic passing, catching and shooting functions of lacrosse.

Another aspect of the present invention relates to a lacrosse pocket comprising a preformed composite material including an outer edge for attaching to a lacrosse head and an interior channel within the outer edge having a desired concave shape and depth, wherein the interior channel, for receiving and releasing a lacrosse ball, permanently maintains the desired concave shape and depth.

In a feature of this aspect, the composite material is selected from any of EVA foam, nylon, thermoplastics, and polyester.

In another feature of this aspect, the composite material includes an EVA foam layer laminated on the top and bottom of the foam layer by a stretch nylon fabric.

In another feature of this aspect, the outer edge includes a plurality of holes for stringing the composite material to a lacrosse head.

In another feature of this aspect, the pocket further comprises a plurality of tabs, the tabs including a male part and a female part, wherein the male part of each of the plurality of tabs is inserted into one of the plurality of holes and wrapped around a sidewall of the lacrosse head, such that the male part is inserted into the female part of the tab.

In another feature of this aspect, the composite material has a customized design printed on the interior channel.

Another aspect of the present invention relates to a method for manufacturing a pre-formed lacrosse pocket for attaching to a lacrosse head. The method comprises the steps of laminating a second material to the top and bottom of a first material to create a composite material, heating the composite material, and pressing a mold having a desired concave shape and depth into the heated composite material, thereby forming an interior channel for receiving and releasing a lacrosse ball, wherein the formed interior channel permanently maintains the desired concave shape and depth.

In a feature of this aspect, the method further comprises cutting an outer edge of the composite material including the formed interior channel to the shape of a lacrosse head.

In another feature of this aspect, the first and second materials are selected from any of EVA foam, nylon, thermoplastics, and polyester.

In another feature of this aspect, the first material is an EVA foam and the second material is a stretch nylon fabric.

Another aspect of the present invention relates to a lacrosse head comprising a scoop, a throat, a sidewall, and a pre-formed lacrosse pocket, the pre-formed lacrosse pocket comprising a preformed composite material including an outer edge for attaching to a lacrosse head and an interior channel within the outer edge having a desired concave shape and depth, wherein the interior channel, for receiving and releasing a lacrosse ball, permanently maintains the desired concave shape and depth.

In a feature of the present invention, the composite material is selected from any of EVA foam, nylon, thermoplastics, and polyester.

In another feature of the present invention, the composite material includes an EVA foam layer laminated on the top and bottom of the foam layer by a stretch nylon fabric.

In another feature of the present invention, the outer edge includes a plurality of holes for stringing the composite material to the sidewall.

In another feature of the present invention, the pre-formed lacrosse pocket further comprising a plurality of tabs, the tabs including a male part and a female part, wherein the male part of each of the plurality of tabs is inserted into one of the plurality of holes and wrapped around the sidewall of the lacrosse head, such that the male part is inserted into the female part of the tab.

In another feature of the present invention, the composite material has a customized design printed on the interior channel.

In addition to the aforementioned aspects and features of the present invention, it should be noted that the present invention further encompasses the various possible combinations and sub combinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 illustrates an example of a prior art hard mesh pocket;

FIG. 2 illustrates an example front perspective view of an implementation of a pre-formed pocket in accordance with the present invention;

FIG. 3 illustrates an example right side view of the pre-formed pocket shown in FIG. 2;

FIGS. 4 illustrates an example implementation of the pre-formed pocket shown in FIG. 2 attached to a lacrosse head;

FIG. 5 illustrates an example flow diagram of a disclosed implementation of a method for manufacturing the disclosed pre-formed pocket in accordance with the present invention;

FIG. 6 illustrates an example laminating of a selected material in accordance with the present invention;

FIG. 7 illustrates an example of a die cut composite material in accordance with the present invention;

FIG. 8 illustrates an example of the pocket mold pressed into the composite material in accordance with the present invention;

FIGS. 9 and 10 illustrate examples of pre-formed pockets including cutouts in accordance with another implementation of the present invention; and

FIG. 11 illustrates an example of a pre-formed pocket having a customized design printed thereon in accordance with another implementation of the present invention; and

FIG. 12 illustrates an example preformed pocket including a plurality of tabs in accordance with an alternate implementation of the present invention.

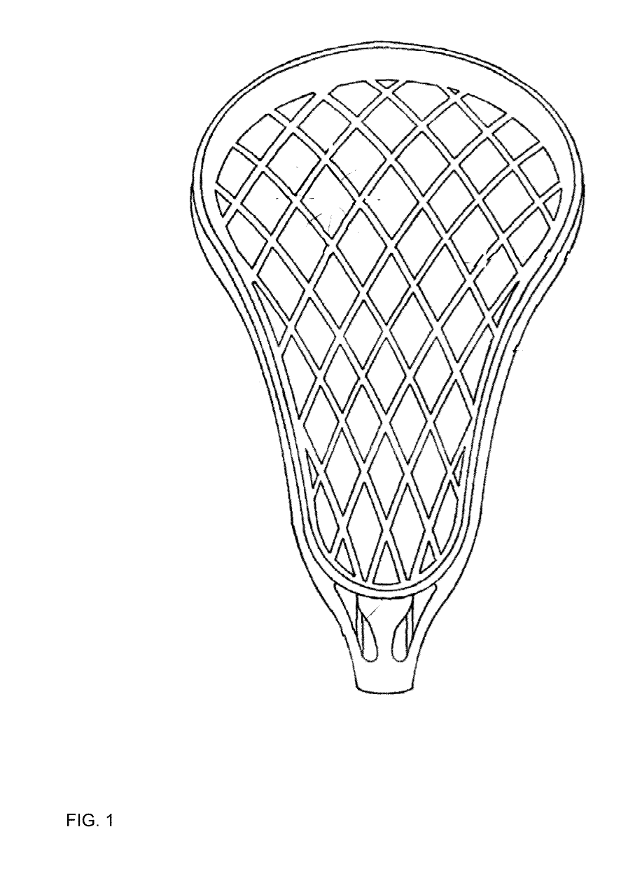

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed; to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

The following description of one or more preferred embodiments is merely exemplary in nature and is in no way intended to limit the invention, its implementations, or uses.

A pre-formed pocket made from composite material and a method for manufacturing same is disclosed. The disclosed pre-formed pocket permanently maintains its shape without requiring a user to continue to “break in” the pocket. The pre-formed pocket maintains form and provides the advantages to a user seen from a traditionally “broken in” pocket. The disclosed pre-formed pocket provides a solution that can bridge the equipment gap for entry and intermediate players so he/she can get through the early stages of learning the sport without having to worry about creating a “pocket”.

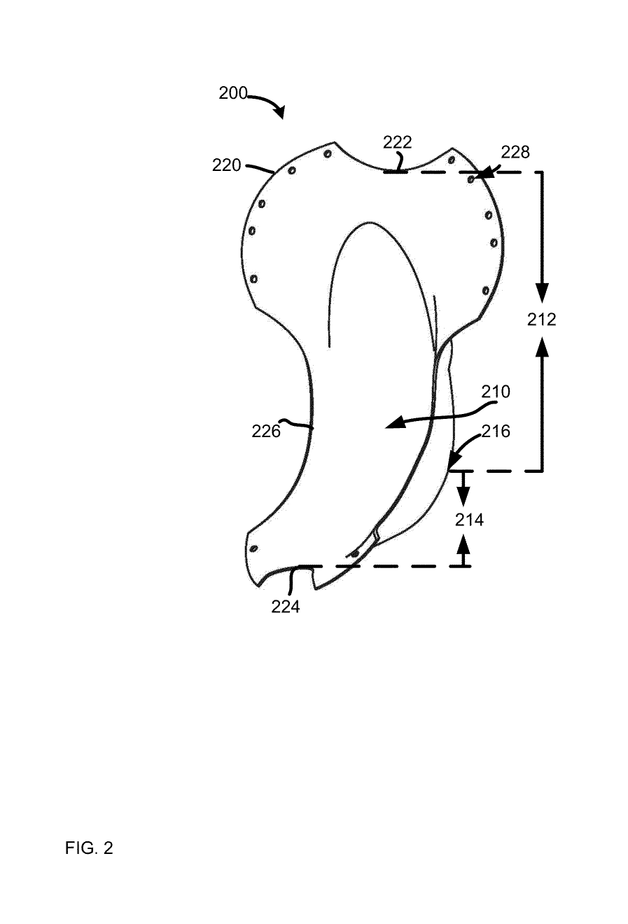

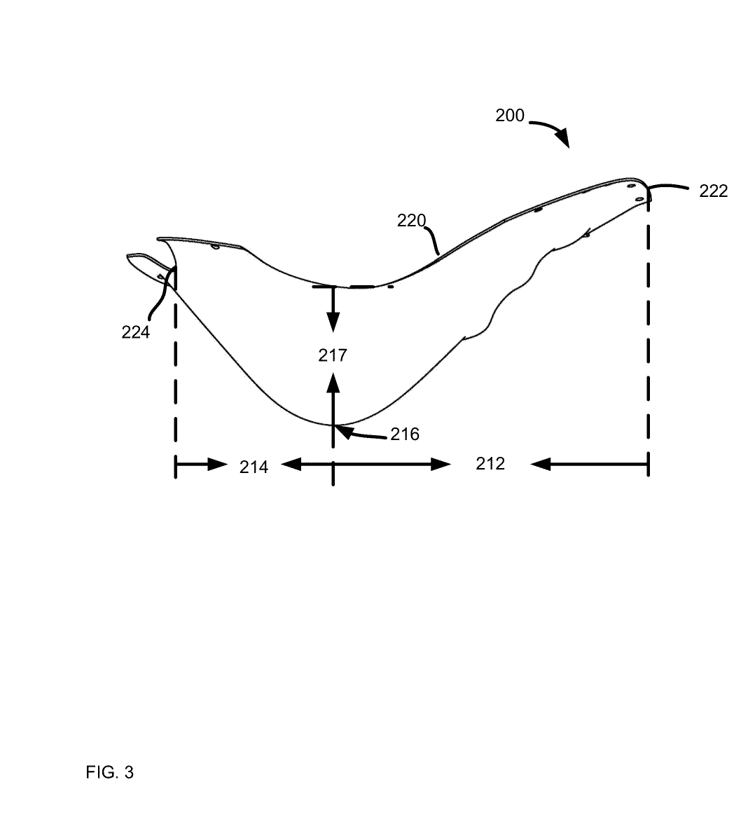

An illustration of an example implementation of a disclosed pre-formed pocket is shown in FIGS. 2 and 3. Referring to FIG. 2, the disclosed pre-formed pocket 200 includes an interior channel 210 and an outer edge 220. The outer edge 220 includes an upper edge 222, a lower edge 224, side edges 226 and a plurality of holes 228 for attaching the pocket 200 to a lacrosse head. The plurality of holes 228 preferably are set to match the holes of the lacrosse head for which it is to be used so that a user is able to string the pocket 200 to the lacrosse head.

Referring to FIG. 3, the interior depth 210 includes an upper interior face 212, a lower interior face 214 and an apex 216. The apex 216 of the pocket 200 is the lowest point of the interior channel 210, i.e., the intersecting point of the upper and lower interior faces 212, 214, respectively. The depth 217 of the interior channel 210 is measured from the apex 216 to the outer edge 220. As those having skill in the art know, the depth 217 of the pocket is determined by the user's preference and skill level. For the purposes of this disclosure, the depth 217 of the pocket 200 is the legal depth set forth in the US Lacrosse specification. As will be discussed below, in the alternative, the user may define his/her desired depth and the preformed pocket 200 will be manufactured accordingly.

The upper edge 222 is the portion of the outer edge 220 that attaches to the scoop of a lacrosse head. The lower edge 224 is that portion of the outer edge 220 that attaches to the throat of the lacrosse head.

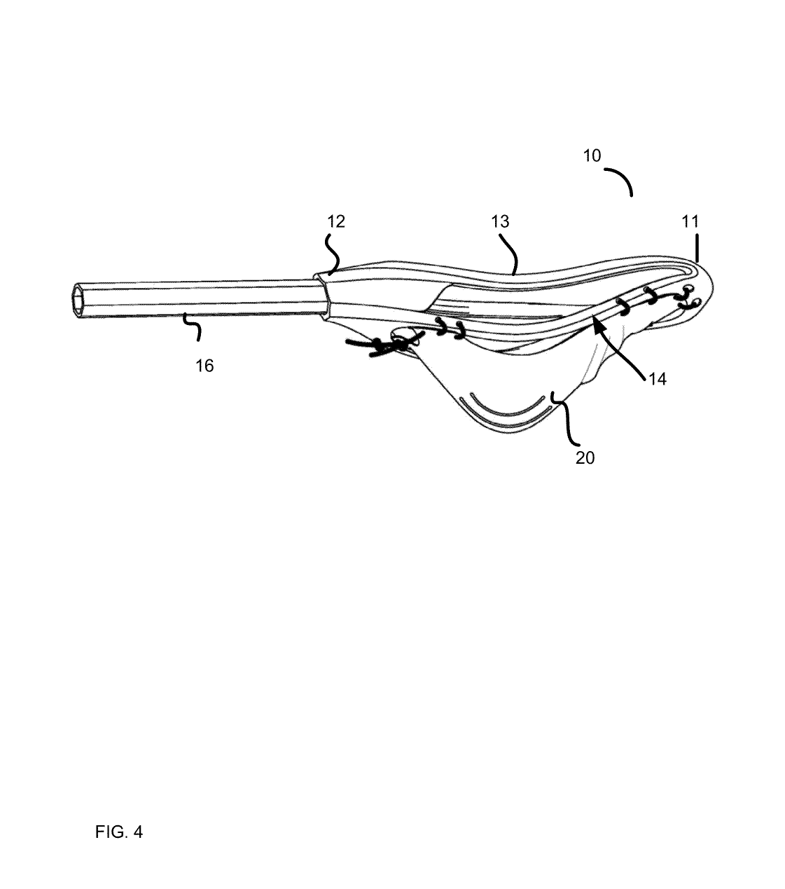

An example illustration of a lacrosse head and stick is shown in FIG. 4. The lacrosse head 10 includes a scoop 11, a throat 12, for attaching the head 10 and a stick 16, an upper sidewall 13 and lower sidewall 14. As those skilled in the art know, a pocket 20 may be attached to the lower sidewall 14.

Referring back to FIGS. 2 and 3, the upper interior face 212 of the interior channel 210 is the area of the pocket 200 located between the apex 216 and the upper edge 222. The lower interior face 214 of the interior channel 220 is the area of the interior of the pocket 200 located between the apex 216 and the lower edge 224. In accordance with the disclosed, the location of the interior channel's 210 apex 216 is set relative to upper edge 222 and the lower edge 224. As those having skill in lacrosse know, the location of the interior channel 210 is determinative of a user's throwing mechanics and passing and shooting style, and how easy/hard it is for the user to pick-up ground balls and cradling.

A low pocket indicates that the apex 216 of the interior depth 210 is close to the lower edge 224 of the pocket 220, i.e., the apex 216 is closer to the throat than it is to the scoop of a lacrosse head when the pocket is attached to the lacrosse head. Accordingly, the upper interior face 212 is longer and shallower than the lower interior face 214.

A high pocket location indicates that the apex 216 of the interior channel 210 is closer the to the upper edge 222 of the pocket 200, i.e., the apex 216 is closer to the scoop of the lacrosse head than it is to the throat when the disclosed pocket 200 is attached to the lacrosse head. Accordingly, the lower interior face 214 is longer and shallower than the upper interior face 212.

A mid pocket location indicates that the apex 216 of the interior depth 210 is in the middle of the pocket 200, midway between the lower edge 224 and the upper edge 222.

In accordance with the disclosed pre-formed pocket 200, the interior channel shape and positioning in the pocket are permanent. When the pocket 200 is manufactured, to be disclosed hereinafter, the pocket 200 maintains it shape and depth without requiring a user to do anything to maintain the pocket's shape.

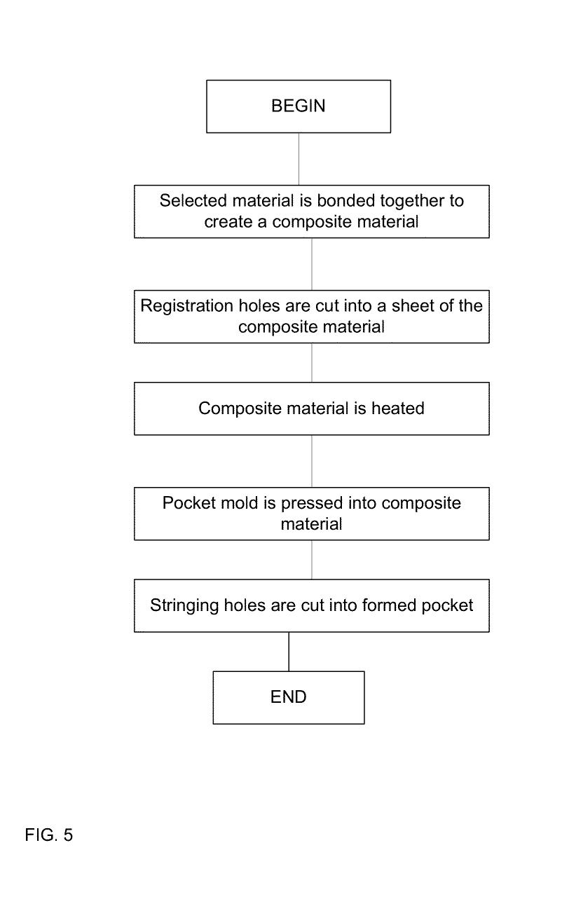

A method for manufacturing the disclosed pre-formed pocket includes determining a desired pocket, including the shape, depth and position of the interior depth. An example flow diagram of an implementation of a disclosed method of manufacturing is shown in FIG. 5. A solid geometry of a desired pocket is generated to create a mold for the pre-formed pocket, then provided to a tooler to generate a mold.

In accordance with a preferred implementation, selected materials are bonded together to create a sheet of composite material. STEP 500. As known by those having skill in the art, composite materials are made from two or more constituent materials with significantly different physical or chemical properties, that when combined, produce a material with characteristics different from the individual components. The individual components remain separate and distinct within the finished structure. The type of material may be any non-mesh material that can be formed using heat and/or pressure. Example materials for the disclosed pre-formed pocket include, but are not limited to, nylon, polyester, foam, and thermoplastics. In the disclosed implementation, EVA foam and stretched nylon are the preferred materials to be combined.

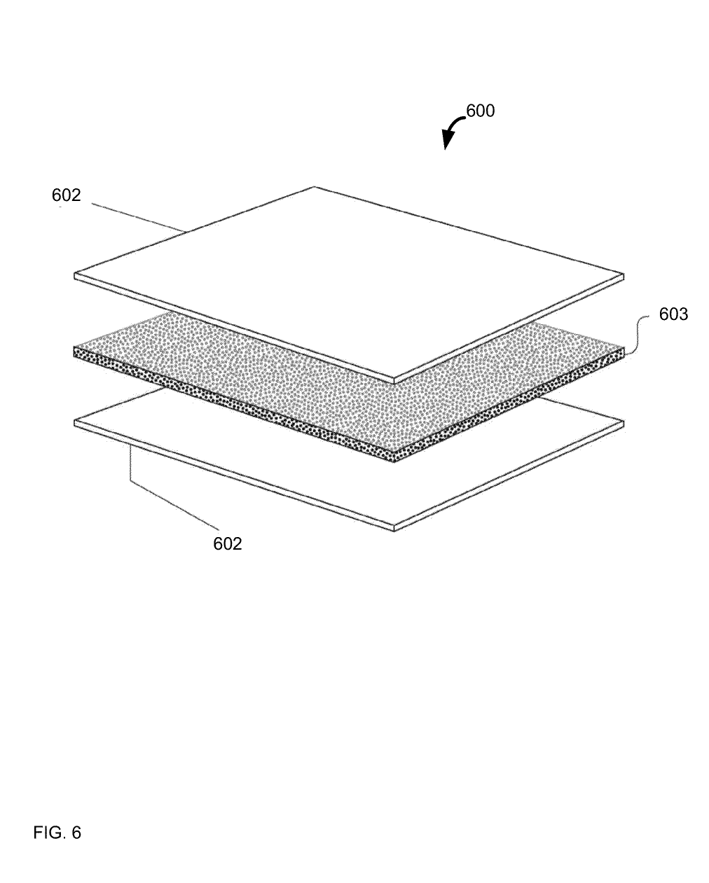

An example illustration of the laminated composite material is shown in FIG. 6. As shown, a first material 603, EVA foam, is laminated on both sides by a second material 602, preferably a 4 way stretch nylon fabric. Using heat and a chemical process, the materials are bonded together to produce the composite material used for the pre-formed pocket.

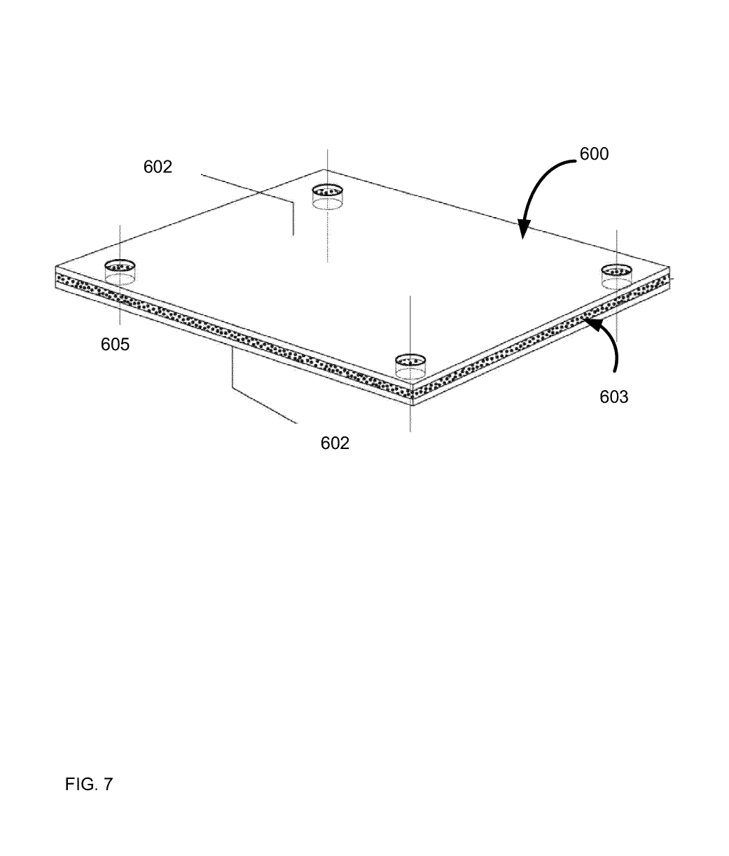

Referring back to FIG. 5, once the composite material is produced, the sheet of composite material is cut into a plurality of rectangle sheets. Registration holes are then die cut into a rectangle sheet of the composite material. STEP 501. An example illustration of the die cut composite material is shown in FIG. 7.

In another implementation, a mesh pattern of the cutouts may also be die cut into the sheet of composite material, wherein the design of the mesh pattern may resemble a traditionally strung material pocket and/or a woven mesh material pocket, to be disclosed below.

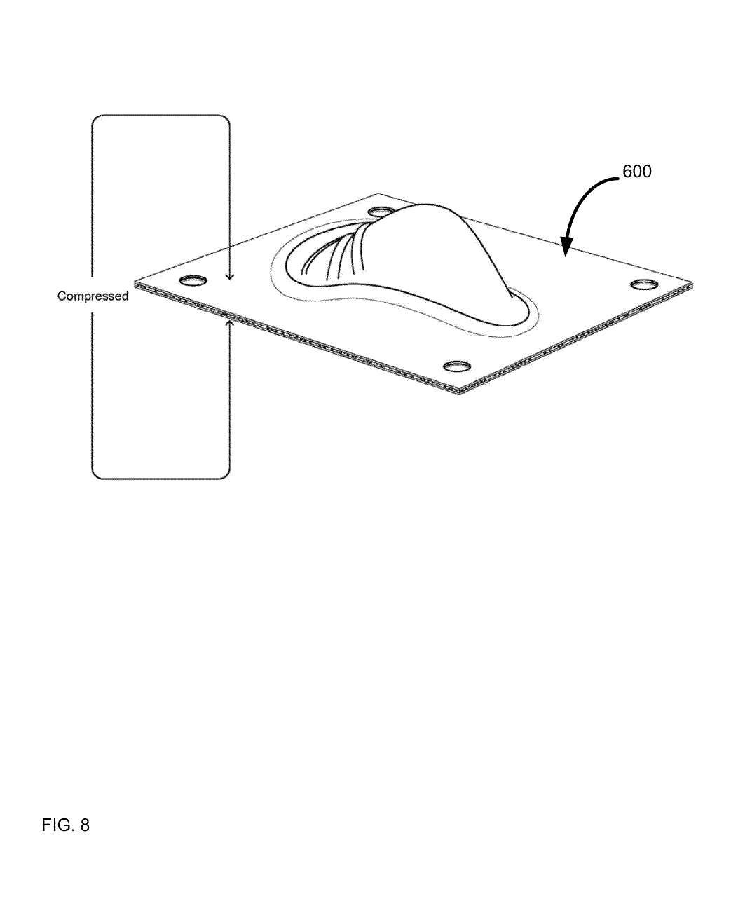

Referring back to FIG. 5, the die cut composite material is then heated, STEP 502, and the mold pressed into the heated composite material, forming the pocket. STEP 503. An example illustration of the mold pressed into the composite material is sown in FIG. 8. Once the pocket has been formed, the stringing holes are die cut into the composite material that are used to attach to a lacrosse head. STEP 504. Any finishing needed for the edges is then completed and/or pattern cut out of the pocket.

Once production is completed on the pre-formed pocket the pocket is packaged. The packaging may be designed to replicate the shape of the preformed pocket, such as in the form of a clamshell packaging.

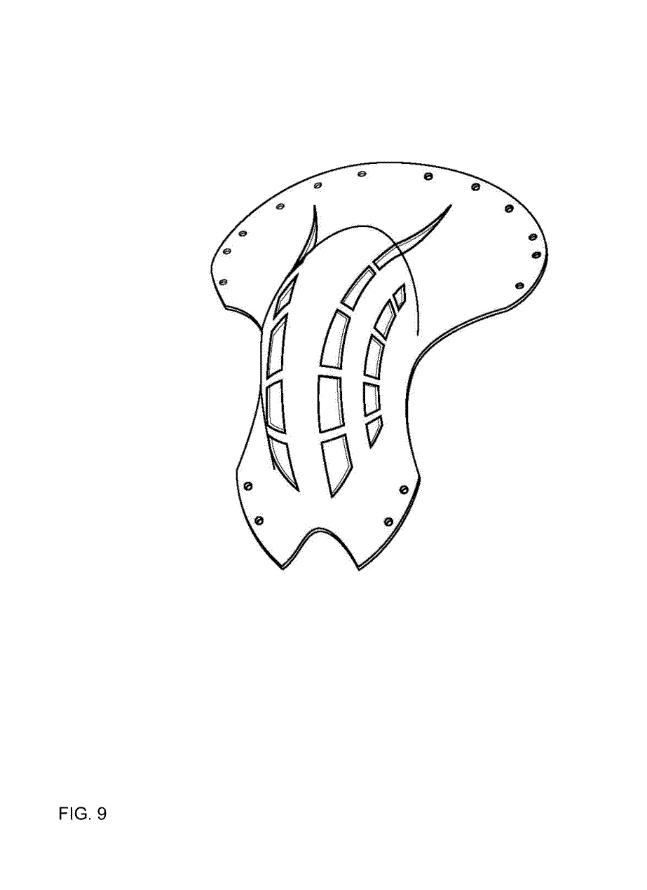

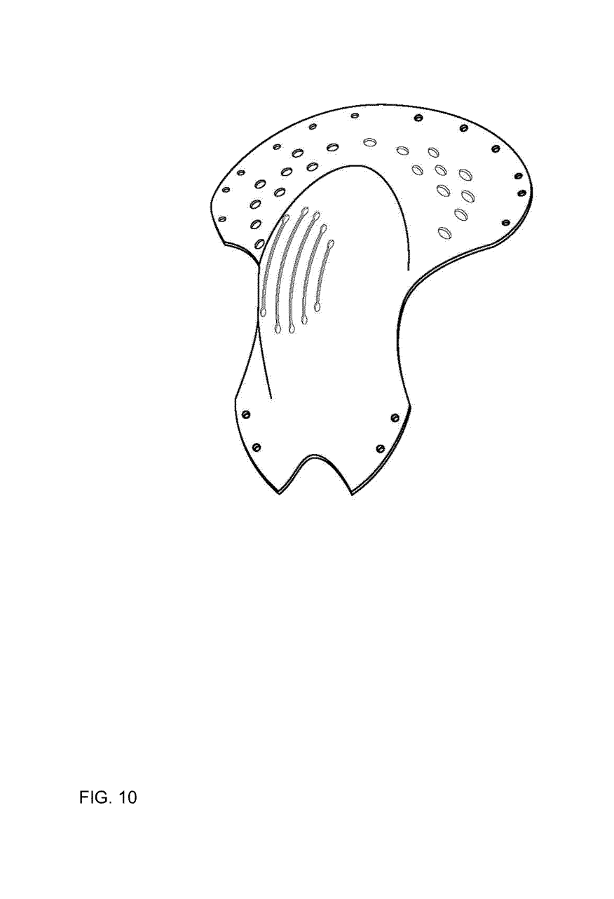

As disclosed above, in an alternative implementation, a plurality of cut outs are made during manufacturing to resemble a mesh pattern design. It is preferable that the cut outs are die cut at the time the registration holes are cut. Alternatively, the cut outs may be die cut after the pocket has been formed. Example illustrations of pre-formed including differing cutout patterns are shown in FIGS. 9-10. Each pattern illustrated may provide advantages in how the lacrosse ball responds for the user.

In another alternative implementation, a pre-formed pocket may be manufactured to emulate the pocket of another lacrosse player, for example a lacrosse professional player or a player's own perfect pocket. A selected pocket could be 3D scanned into a computing device and the image used to create a solid geometry for generating a mold. The mold would then be used to produce the pre-formed pocket as disclosed above.

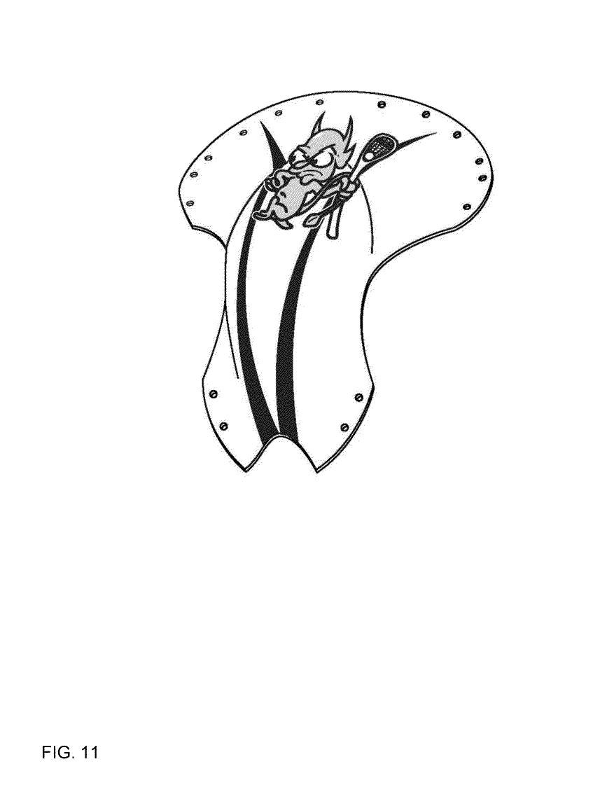

In another implementation, the pre-formed pocket may be customized with a design, for example, a college lacrosse team's logo, on the sheet of composite material, e.g., prior to placing the sheet of material on the mold or after the pocket has been formed, using screen printing, sublimation, etc. An example of a pre-formed pocket having a customized design is illustrated in FIG. 11.

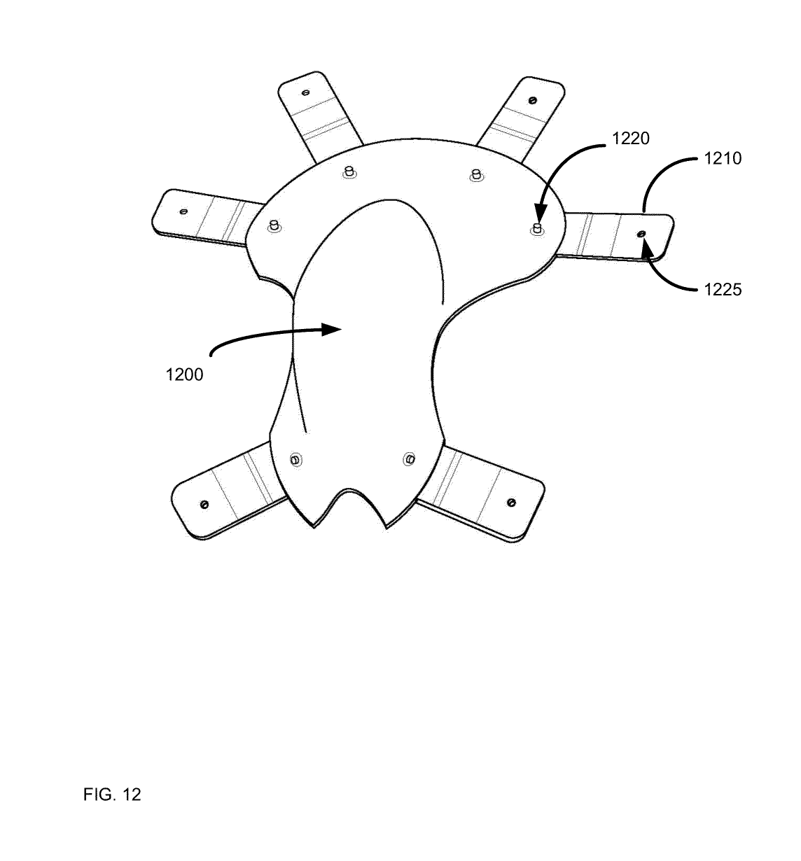

In an alternate implementation, the pre-formed pocket includes a plurality of tabs. An example illustration of the pre-formed pocket 1200 including the plurality of tabs is shown in FIG. 12. Each of the plurality of tabs 1210 comprise a male part 1220 and female part 1225. The male part 1220 fits within the holes on the outer edge of the pre-formed pocket 1200. The pre-formed pocket is attached to a lacrosse head by wrapping the tabs 1210 around the sidewall of the lacrosse head such that the male part 1220 is inserted into the female part 1225.

In an alternative implementation, the pre-formed pocket may be manufactured using injection molding. The material of the pocket may be made from a plastic material or an EVA foam.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof

What is claimed is:

1. A lacrosse pocket comprising:
a preformed composite material including an outer edge for attaching to a lacrosse head and an interior channel within the outer edge having a desired concave shape and depth;
wherein the interior channel, for receiving and releasing a lacrosse ball, permanently maintains the desired concave shape and depth.

2. The lacrosse pocket of claim 1, wherein the composite material is selected from any of EVA foam, nylon, thermoplastics, and polyester.

3. The lacrosse pocket of claim 2, wherein the composite material includes an EVA foam layer laminated on the top and bottom of the foam layer by a stretch nylon fabric.

4. The lacrosse pocket of claim 2, wherein the outer edge includes a plurality of holes for stringing the composite material to a lacrosse head.

5. The lacrosse pocket of claim 4 further comprising a plurality of tabs, the tabs including a male part and a female part;
wherein the male part of each of the plurality of tabs is inserted into one of the plurality of holes and wrapped around a sidewall of the lacrosse head, such that the male part is inserted into the female part of the tab.

6. The lacrosse pocket of claim 4, wherein the composite material has a customized design printed on the interior channel.

7. A method for manufacturing a pre-formed lacrosse pocket for attaching to a lacrosse head, the method comprising the steps of:
laminating a second material to the top and bottom of a first material to create a composite material;
heating the composite material; and
pressing a mold having a desired concave shape and depth into the heated composite material, thereby forming an interior channel for receiving and releasing a lacrosse ball;
wherein the formed interior channel permanently maintains the desired concave shape and depth.

8. The method of claim 7 further comprising cutting an outer edge of the composite material including the formed interior channel to the shape of a lacrosse head.

9. The method of claim 8, wherein the first and second materials are selected from any of EVA foam, nylon, thermoplastics, and polyester.

10. The lacrosse method of claim 9, wherein the first material is an EVA foam and the second material is a stretch nylon fabric.

11. A lacrosse head comprising:
a scoop;
a throat;
a sidewall; and
a pre-formed lacrosse pocket, the pre-formed lacrosse pocket comprising a preformed composite material including an outer edge for attaching to a lacrosse head and an interior channel within the outer edge having a desired concave shape and depth;
wherein the interior channel, for receiving and releasing a lacrosse ball, permanently maintains the desired concave shape and depth.

12. The lacrosse head of claim 11, wherein the composite material is selected from any of EVA foam, nylon, thermoplastics, and polyester.

13. The lacrosse head of claim 12, wherein the composite material includes an EVA foam layer laminated on the top and bottom of the foam layer by a stretch nylon fabric.

14. The lacrosse head of claim 12, wherein the outer edge includes a plurality of holes for stringing the composite material to the sidewall.

15. The lacrosse head of claim 14, wherein the pre-formed lacrosse pocket further comprising a plurality of tabs, the tabs including a male part and a female part;
wherein the male part of each of the plurality of tabs is inserted into one of the plurality of holes and wrapped around the sidewall of the lacrosse head, such that the male part is inserted into the female part of the tab.

16. The lacrosse head of claim 14, wherein the composite material has a customized design printed on the interior channel.
